(19) United States
(12) Patent Application Publication
(10) Pub. No.: US 2007/0174863 A1
(43) Pub. Date: Jul. 26, 2007

(54) Settop box providing contents corresponding to different user identifications

(76) Inventor: Chien-Liang Chen, Taipei City (TW)

Correspondence Address: RABIN & Berdo, PC, 1101 14TH STREET, NW, SUITE 500, WASHINGTON, DC, 20005, US

(21) Appl. No.: 11/337,602

(22) Filed: Jan. 24, 2006

(51) Int. Cl. H04N 7/16; H04N 7/173

(52) U.S. Cl. 725/25; 725/100; 725/131

(57) ABSTRACT

A settop box providing different program or service contents corresponding to different user identifications is connected to the back-end control center and provides video signal to a display unit. The settop box includes a sub-system for reading relative data of user identification and transferring it to the back-end control center. The back-end control center checks the user identification and makes it mapping with a user identification database and provides video signals to the display unit according to a service or program list corresponding to the user identification. Therefore, the user gets program of service of his or her needs without further unnecessary watching or selections.

### BACKGROUND OF THE INVENTION

1. Field of Invention

The invention generally relates to settop boxes, and in particular relates to a settop box that provides different program or service contents corresponding to different user identifications.

2. Related Art

Conventional cable television programs are provided by the provider to the user through a coaxial cable in a fixed channel combination of analog signals. The channels are wholly transmitted, then, selected by the user through a television tuner. This kind of program selection has the following drawbacks. First, the user has to pay a whole channel fee though he or she actually only prefers a part of them. There is no choice for the user. Secondly, the programs are preset in specific schedules that are not accommodated to user's convenience and the user easily misses the time. Thirdly, the channels are versatile that it is unable to block children in the family watching unsuitable programs. It is also unable to define the program watching time.

Therefore, there have been program-selectable broadcasts charged by pay-per-view or time-base. The user pays according to his or her watching without paying excessive fees. This kind of program selection is based on member registration. It provides programs and channels for the user to select. Because of the member registration, it can prevent children operating the television and help parents the watching management. However, this method still has shortcomings that the numerous and diverse programs make the channel selection difficult so that the user may waste much time to seek the programs. And, there are still many items that the user doesn't need. They could cause mistake operations and cause unintentional expenses.

### SUMMARY OF THE INVENTION

The object of the invention is to provide a settop box providing different program or service contents according to different user identifications. It automatically provides different program or service contents based on user identification.

A settop box of the invention that provides different program or service contents according to different user identifications is connected to back-end control center including a video-on-demand (VOD) server and provides video signals to a display unit. The settop box includes a sub-system for reading data of a user's (member) identification and transferring it to the control center. The control center identifies the user identification and makes the user identification data mapping with a user identification database and provides video signals to the display unit according to a service or program list corresponding to the user identification. Therefore, the user gets program of service of his or her needs without further unnecessary selections.

The advantage of the invention is that the system identifies the user's identification and provides specific program or service contents to meet the user's needs. The user doesn't need to seek the service contents slowly from numerous options.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a systematic block diagram of the invention;

FIG. 2 is a descriptive view of a user identification database in an embodiment of the invention;

FIG. 3 is perspective view of a first embodiment the invention;

FIG. 4 is perspective view of a second embodiment the invention;

FIG. 5 is perspective view of a third embodiment the invention;

FIG. 6 is perspective view of a fourth embodiment the invention; and

FIG. 7 is perspective view of a fifth embodiment the invention.

### DETAILED DESCRIPTION OF THE INVENTION

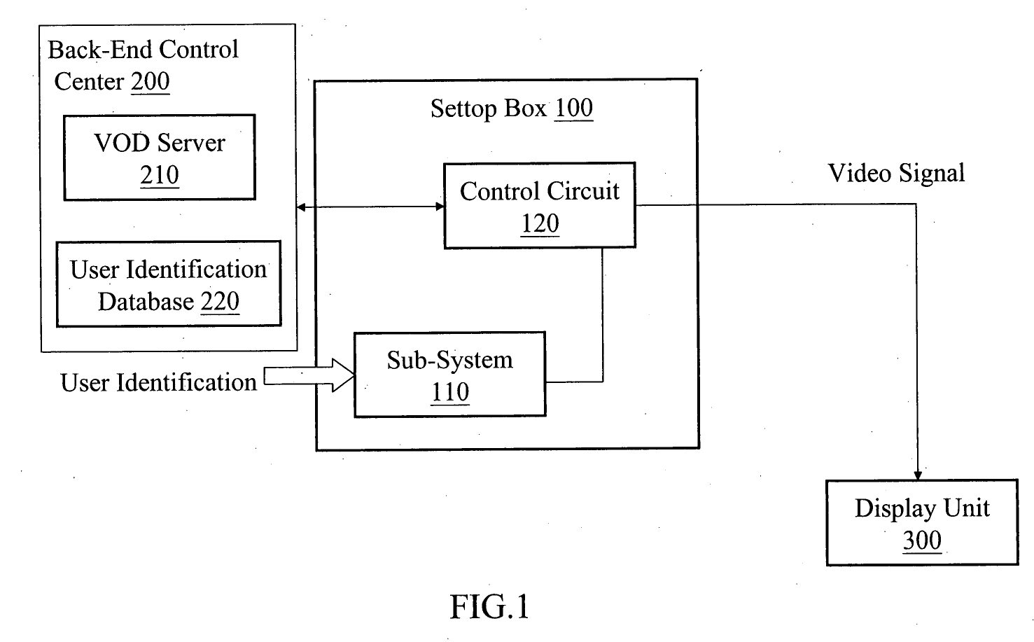

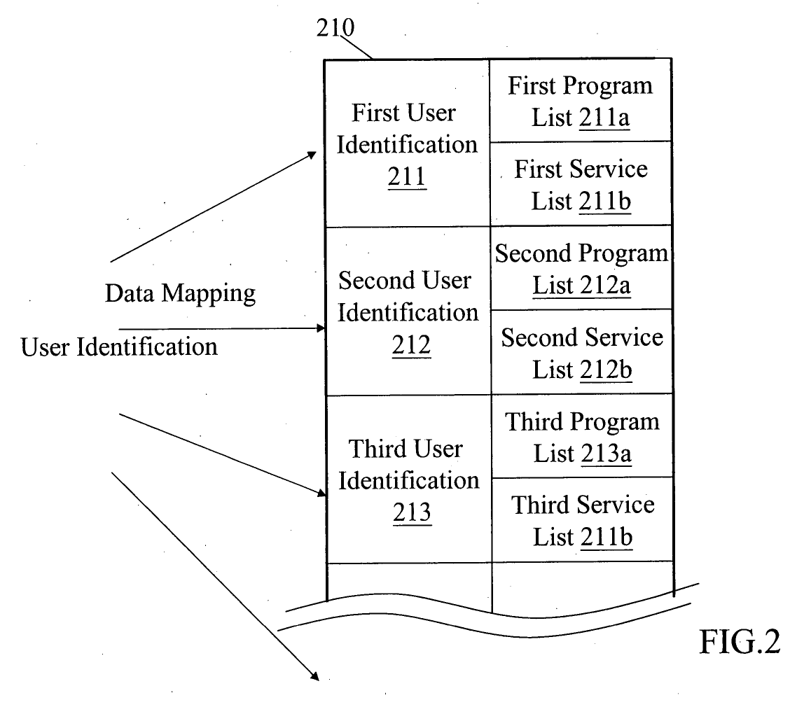

As shown in FIG. 1 and FIG. 2, a systematic block diagram of the invention, a settop box 100 of the invention providing contents corresponding to user identifications is connected to a back-end control center 200 including a video-on-demand (VOD) server 210 and provides video signal to a display unit 300. The back-end control center 200 checks the user identification and makes the user identification data mapping with a user identification database and provides video signals to the display unit 300 (such as a television or a monitor) according to a service or program list corresponding to the user identification. The service or program list is pre-arranged and stored in the user identification database 220 in the back-end control center 200. Therefore, the user inputs user identification data through the settop box 100 and gets program of service of his or her needs via the display unit 300 without further unnecessary selections. There are no other unnecessary or confusing contents to cause misuse or inconvenience.

The settop box includes a sub-system 110 for reading relative data of user identification and transferring it via a control circuit 120 to the back-end control center 200. The sub-system 110 includes reading device for reading the user identification data.

The control circuit 120 is connected with the sub-system 110, the VOD server 210 and the display unit 300. The control circuit 120 transfers the user identification data from the sub-system 110 to back-end control center 200, and then transfers video signals with specific service or program contents corresponding to the user identification from the VOD server 200 to the display unit 300.

The back-end control center 200 includes a user identification database 220 for storing preset program or service lists of each user. As shown in FIG. 2, a first user identification 211 corresponds to a first program list 211a and a first service list 211b; a second user identification 212 corresponds to a second program list 212a and a second service list 212b; a third user identification 213 corresponds to a third program list 213a and a third service list 213b, and so on.

The back-end control center 200 checks the user identification data from the settop box 100 and makes it mapping with the user identification database 210 and provides video signals to the settop box 100 and the display unit 300 according to the corresponding service and program lists. For a pay-per-view (PPV) television, the fee could be then counted or charged.

In a family, the settop box 100 is applicable to different family members for presetting different programs or services. For example, children are preset with suitable programs and time of view so as to be prevented from viewing unsuitable programs. The back-end control center 200 provides only the preset contents when receiving the specific user identification.

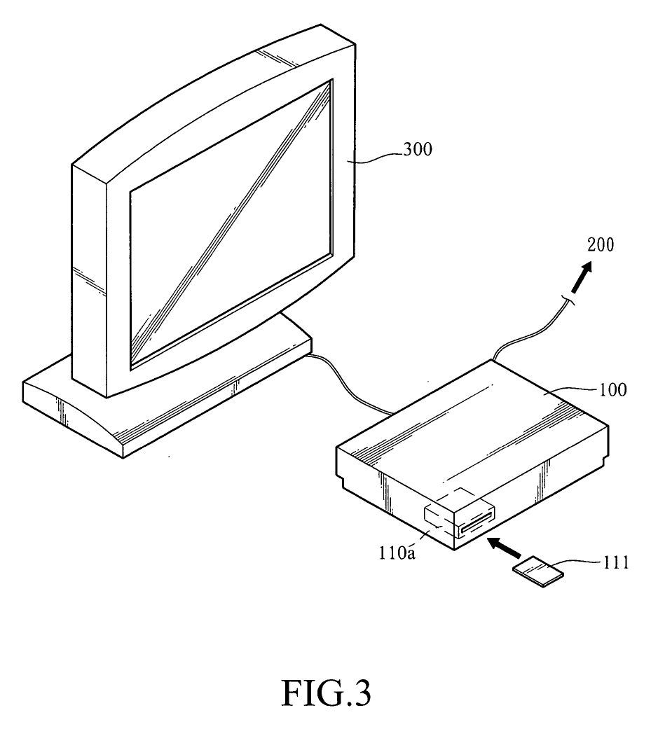

The user identification data can be inputted via different kinds of devices. For example, as shown in FIG. 3, the sub-system 110 includes a data reader 110a for reading a data storage unit 111. The user identification data is stored in the data storage unit 111. When the data storage unit 111 is inserted in the data reader 110a, the user identification data is read and transferred from the settop box 100 to the back-end control center 200. The data storage unit 111 can be a Smart Card, and the data reader can be a Smart Card reader. The data storage unit 111 also stores prepayment records for payments of pay-per-view (PPV) television. Of course, other kinds of data storage units 111, such as magnetic cards or other data storage media can also be used.

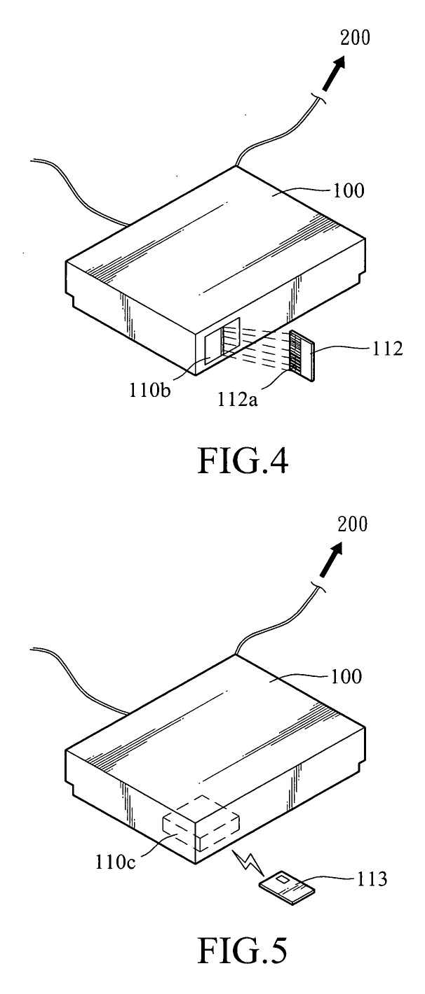

As shown in FIG. 4, the sub-system 110 includes a barcode reader 110b for reading a barcode 112a printed on a card 112 (made of paper, plastic sheet or any suitable material). When the card 112 is placed in front of the reader 110b, the user identification data coded in the barcode 112a is read and transferred to the back-end control center 200.

As shown in FIG. 5, the sub-system 110 includes a radio frequency identification (RFID) reader 110c for reading a radio frequency identification (RFID) tag 113 containing user identification data. When the RFID tag 113 is presented near the settop box 100, the radio frequency identification reader 110c detects the user identification data and transfers to the back-end control center. In order to prevent interference among several RFID tags 113 presenting at the same time to the RFID reader 110c, the settop box 100 can be preset with priority order that only the user identification data of the highest prior RFID tag 113 is transferred. Or, a manual switch can be used to choose a specific RFID tag 113.

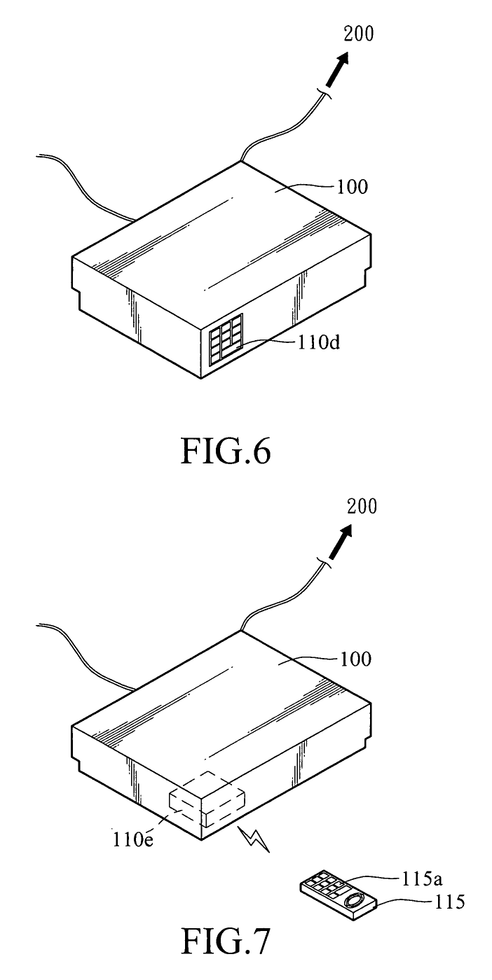

As shown in FIG. 6, the sub-system 110 includes a keyboard 110d for the user to input user identification data to be transferred to the back-end control center 200. The identification data can be a combination of numbers and characters.

As shown in FIG. 7, the sub-system 110 includes a wireless signal receiver 110e for receiving wireless signals containing user identification data and transmitted by a wireless signal transmitter 115. The wireless signal transmitter 115 can be a remote control having a set of keyboard 115a for user to input user identification data to be transferred to the settop box 100. Or, the user identification data is stored in a data storage unit of the wireless signal transmitter 115 and operated by the user to transmit.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An settop box connected to a back-end control center and providing video signal of different program and service contents to a display unit corresponding to different user identifications, comprising:
a sub-system for reading relative data of user identification and transferring said data to the back-end control center which makes the user identification data mapping with a user identification database and provides video signals to the display unit according to a service and program list corresponding to the user identification data.

2. The settop box according to claim 1 wherein said sub-system comprises a keyboard for the user to input the user identification data.

3. The settop box according to claim 1 wherein said sub-system comprises a data reader for reading a data storage unit wherein the user identification data is stored in the data storage unit.

4. The settop box according to claim 3 wherein the a data storage unit is a magnetic card.

5. The settop box according to claim 3 wherein the data storage unit is a Smart Card and the data reader is a Smart Card reader.

6. The settop box according to claim 3 wherein the data reader is a radio frequency identification reader and the data storage unit is a radio frequency identification Tag.

7. The settop box according to claim 1 wherein the sub-system comprises a barcode reader for reading a barcode wherein the user identification is coded in the barcode.

8. The settop box according to claim 1 wherein the sub-system comprises a wireless signal receiver for receiving wireless signals containing the user identification data and transmitted by a wireless signal transmitter.

9. The settop box according to claim 8 wherein said wireless signal transmitter comprises a set of keyboard for user to input the user identification data.
